(19) United States
(12) Patent Application Publication
(10) Pub. No.: US 2023/0286373 A1
(43) Pub. Date: Sep. 14, 2023

(54) AIR-CONDUCTING SYSTEM OF A MOTOR VEHICLE BODY OF A MOTOR VEHICLE

(71) Applicant: Dr. Ing. h.c. F. Porsche Aktiengesellschaft, Stuttgart (DE)

(72) Inventor: Sebastian Harter, Weissach (DE)

(73) Assignee: Dr. Ing. h.c. F. Porsche Aktiengesellschaft, Stuttgart (DE)

(21) Appl. No.: 18/092,474

(22) Filed: Jan. 3, 2023

(30) Foreign Application Priority Data
Mar. 9, 2022 (DE) 10 2022 105 546.9

(51) Int. Cl. B60K 11/08

(52) U.S. Cl. CPC B60K 11/085

(57) ABSTRACT

An air-conducting system of a motor vehicle body of a motor vehicle includes a fin arrangement. The fin arrangement includes at least two fins, which are arranged in a frame of the air-conducting system in a rotatably mounted manner about their axis of rotation. The fins are operatively connected with the aid of a kinematics including a coupling rod for movement transmission. An actuator for movement initiation is assigned to the fin arrangement. The kinematics includes a split coupling rod, wherein at least two four-bar hinges to be assigned to the coupling rod are configured differently from one another.

### CROSS-REFERENCE TO RELATED APPLICATION

This application claims priority to German Patent Application No. 10 2022 105 546.9, filed Mar. 9, 2022, the content of such application being incorporated by reference herein in its entirety.

### FIELD OF THE INVENTION

The invention relates to an air-conducting system of a motor vehicle body of a motor vehicle.

### BACKGROUND OF THE INVENTION

Air-conducting systems for influencing an air flow around and/or through the motor vehicle body are known. For example, air-conducting systems are used in the front region of the motor vehicle body, wherein they allow a defined air flow to be realized in the front region of the motor vehicle body, which serves, for example, to flow against a cooling unit of the motor vehicle.

Flow channels of the air-conducting systems in the front region are known to be equipped with a fin arrangement, preferably a movable fin arrangement, so that the inlet opening of the air-conducting system formed in the front region can be changed and is thus controllable. A flow cross-section of the flow channel can thus be changed with the aid of the fin arrangement, for example, so that an air resistance coefficient and an energy demand of the motor vehicle depending on the air resistance coefficient can be reduced, which, for example, leads to an increased range of the motor vehicle. Individual fins of the fin arrangement are connected with the aid of a common pushrod. A servomotor drives a fin, wherein the initiated rotational movement is transferred to the other fins via the pushrod. The angles of rotation of the fins are usually identical due to having the same levers, which create a connection between the pushrod and the fin. However, due to the thusly configurable equal opening angles of the fins in each position, there can be an inefficiency of the air-conducting system in certain operating ranges of the motor vehicle.

This can be reduced or eliminated to the extent that the fins have different opening angles in one position.

For example, DE 692 00 726 T2, which is incorporated by reference herein, discloses an air-conducting system of a motor vehicle body for controlling the air flow through a heat exchanger, wherein the system comprises several flaps arranged side-by-side and driven via a pushrod, and wherein each flap is connected to the pushrod via a respective lever. The levers have different lengths so that the flaps are rotated by angles of rotation that are different from one another.

DE 10 2017 116 812 A1, DE 10 2018 211 425 A1, DE 10 2008 049 010 A1, and EP 3 409 524 B1, which are each incorporated by reference herein, disclose a motor vehicle body of a motor vehicle, wherein the air-conducting system is configured in the form of a fin system for an air inlet opening on a front part of a motor vehicle. The fin system comprises several fins arranged side-by-side and driven via a pushrod, wherein each fin is connected to the pushrod via a respective lever. The levers here also have different lengths so that the fins are rotated by angles of rotation that deviate from one another.

DE 10 2020 107 273 A1, which is incorporated by reference herein, discloses a fin system for an air inlet opening on a front part of a motor vehicle, wherein the fin system comprises several fins arranged side-by-side and driven via a pushrod. Each fin is connected to the pushrod by means of a lever, wherein the levers have different lengths. Furthermore, the levers engage in elongated holes of the pushrod, which are respectively designed differently, wherein the fins are twisted by angles of rotation that are different from one another.

EP 2 911 900 B1, which is incorporated by reference herein, also discloses an air-conducting system of a motor vehicle body of a motor vehicle in the form of a fin system for an air inlet opening on a front part of the motor vehicle, having several fins arranged side-by-side and driven via a motion link guide.

DE 101 30 951 A1, which is incorporated by reference herein, discloses a fin system for a motor vehicle, having several fins and several pushrods for adjusting the angle of rotations of the fins, which deviate from one another.

U.S. Pat. No. 1,706,338, which is incorporated by reference herein, discloses a fin system for a motor vehicle, having several fins and several pushrods.

### SUMMARY OF THE INVENTION

An air-conducting system of a motor vehicle body of a motor vehicle according to aspects of the invention comprises a fin arrangement having at least two fins, which are arranged in a frame of the air-conducting system in a rotatably mounted manner about their axis of rotation. The fins are operatively connected with the aid of a kinematics comprising a coupling rod for movement transfer, wherein an actuator is assigned to the fin arrangement for movement initiation. According to the invention, the kinematics comprises a split coupling rod, wherein at least two four-bar hinges to be assigned to the coupling rod are configured differently from one another. That is to say, at least two of the four-bar hinges, which are configured so as to be connected to the coupling rod, are arranged differently from one another. The advantage is that, in a position of the fin arrangement, the fins can be set having different opening angles by way of a robust, dirt-insensitive, low-wear, and low-noise kinematics.

These different opening angles lead to an increase in a fresh air mass flowing into the fin arrangement, because the fins can be aligned parallel to abutting flow filaments during operation of the motor vehicle. Further significant advantages of the air-conducting system according to aspects of the invention compared to the known air-conducting systems are the transmission of high forces even in small construction spaces, and hinge points of the four-bar hinge can be designed nearly clearance-free.

When a number of the different four-bar hinges corresponds to a number of the fins of the fin arrangement, the advantage is that all four-bar hinges assigned to the fins, thus a so-called countershaft hinge, are designed differently. The countershaft hinge corresponds to the hinge arranged between the actuator and the fin driven by the actuator.

Advantageously, one of the four-bar hinges, which has an achievable largest opening angle, is assigned to an outer fin so that a further increase in the fresh air mass can be realized, wherein, in particular, the outer fin is to be arranged facing a body exterior of the motor vehicle body.

A further advantage of the air-conducting system according to aspects of the invention can be seen in a realization of a change of an overall image of the motor vehicle that comes with changing the positions of the fin arrangement. Different fannings of the fin arrangement and thus different overall images of the motor vehicle can be easily produced.

A further significant advantage of the air-conducting system according to aspects of the invention can be seen in that, with the aid of the different fin positions, an accident-relevant so-called pendulum can be positioned further inward in the vehicle, so that a robust overlapping between the pendulum and a cross-beam of the motor vehicle body is possible. A pendulum energy is thereby introduced directly into a shell structure of the motor vehicle body, which can reduce the risk of component damage in the event of an accident.

### BRIEF DESCRIPTION OF THE DRAWINGS

Additional advantages, features and details of the invention arise from the following description of preferred embodiment examples and with reference to the drawing. The features and combinations of features mentioned above in the description and the features and combinations of features mentioned below in the description of the figures and/or shown alone in the figures can be used not only in the respectively indicated combination, but also in other combinations or on their own without departing from the scope of the invention. Here:

FIG. 1 shows, in a top plan view, an air-conducting system of a motor vehicle body of a motor vehicle according to the prior art,

FIG. 2 shows, in a perspective rear view, an air-conducting system according to aspects of the invention in a first embodiment example,

FIG. 3 shows, in a top plan view, the air-conducting system according to aspects of the invention in a second embodiment example in its closed position,

FIG. 4 shows, in a perspective view, the air-conducting system according to FIG. 2 in its open position,

FIG. 5 shows, in a perspective view, the air-conducting system according to FIG. 2 in its closed position,

FIG. 6 shows, in a perspective view, the air-conducting system according to FIG. 2 in an intermediate position, and

FIG. 7 shows, in a diagram, the torque and angle of rotation of an air-conducting system according to the prior art and the air-conducting system according to aspects of the invention during a positioning of the air-conducting system proceeding from the closed position to the open position and back to the closed position over time.

### DETAILED DESCRIPTION OF THE INVENTION

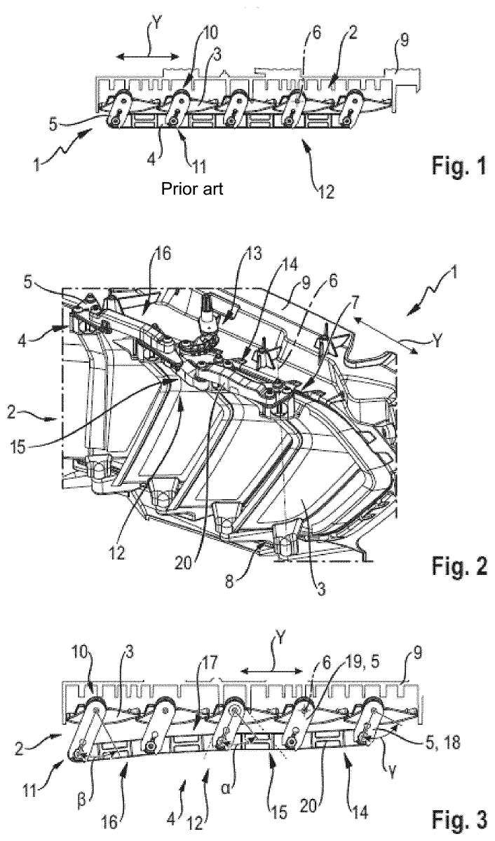

An air-conducting system 1 of a motor vehicle body of a motor vehicle according to the prior art, which is not shown in greater detail, is configured as shown in a top plan view in FIG. 1.

The air-conducting system 1 comprises a fin arrangement 2 having five fins 3, which are synchronously adjustable with the aid of a coupling rod 4. The fins 3 each comprise a lever arm 5 with which they are movably connected to the coupling rod 4.

In principle, a movement of the fins 3 is a rotational movement or a pivoting movement about their axis of rotation 6. The fins 3, which are typically, and in the present embodiment example, predominantly plate-like, are mounted rotatably in a frame 9 of the fin arrangement 2 at their first end 7 and at their second end 8, which is configured so as to face away from the first end 7, as preferably illustrated in FIG. 2, in which an air-conducting system 1 according to aspects of the invention can be seen. In this frame 9, the fins 3 are rotatably accommodated.

The rotational movement, for the synchronous performance of which the fins 3 are configured, is initiated by an actuator of the air-conducting system 1, which is not shown in greater detail, and is usually transferred to at least the fins 3 with the aid of the coupling rod 4.

A movable connection in the form of the lever arm 5 is formed between the fin 3 and the coupling rod 4, which arm is connected to the fin 3 at its first arm-end portion 10 and connected to the coupling rod 4 at its second arm-end portion 11, which is configured so as to face away from the first arm-end portion 10. That is to say, a kinematics 12 is formed comprising the coupling rod 4, the lever arm 5, and the actuator.

The kinematics 12 is configured in principle to produce a relative movement between the fin 3 and the coupling rod 4, a loss-proof fastening of the fin 3 to the coupling rod 4 or vice versa, and the transfer of tensile and compressive forces.

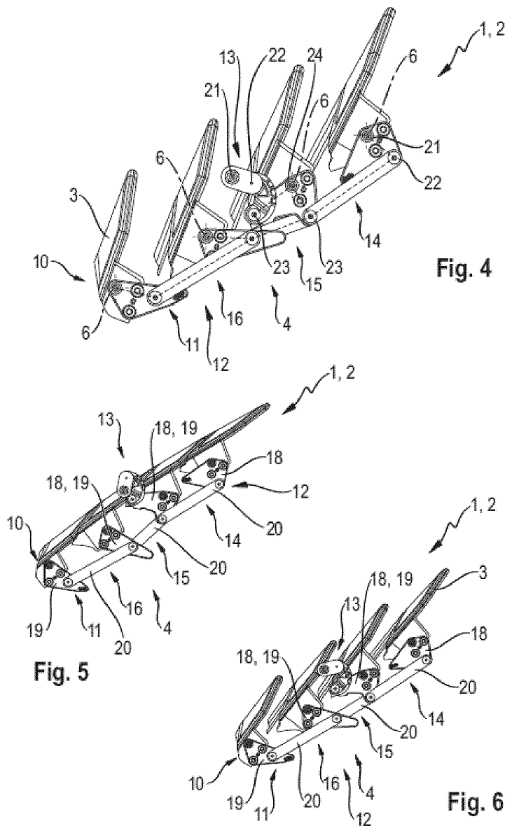

The air-conducting system 1 according to the invention, which is depicted in FIGS. 2 and 4 to 6 in a first embodiment example and in FIG. 3 in a second embodiment example, comprises the kinematics 12 with multiple four-bar hinges and a number of the fins 3 four-bar hinges corresponding to the number of fins, which are configured differently from one another.

The fins 3 are connected to one another with the aid of a split coupling rod 4, wherein the movement is transferred to the remaining fins 3 starting from one of the fins 3 which is connected to the actuator so as to be driven.

According to the first embodiment example, the air-conducting system 1 thus has a first four-bar hinge 13, which is connected to the actuator, a second four-bar hinge 14, which is connected to the outer fin 3 along a frame axis Y and its adjacently arranged fin 3, a third four-bar hinge 15, which is connected to the adjacently arranged fin 3 and its next closest fin 3, and a fourth four-bar hinge 16, which is connected to the next closest fin 3 and the inner fin 3 along the frame axis Y. At this point, it should be mentioned that the assignments “outer” and “inner” were already selected in the motor vehicle body in accordance with an installation position of the air-conducting system 1. That is to say, the outer fin 3 is arranged externally in an installation of the air-conducting system 1 in the motor vehicle body, in other words facing a body outer surface, and the inner fin 3 is arranged so as to face one in the center of the motor vehicle body, viewed along its body transverse axis.

In the second embodiment example, the air-conducting system 1 according to aspects of the invention has a fifth four-bar hinge 17, which is arranged between the third four-bar hinge 15 and the fourth four-bar hinge 16.

The first four-bar hinge 13, which is operatively connected to the actuator, preferably in the form of a servomotor, is furthermore likewise operatively connected to a fin between the outer fin 3 and the inner fin 3. In other words, the actuator is arranged so as to drive a fin 3 configured in a central region of the fin arrangement 2.

A single fin 3 is driven, which, with the aid of its rotational movement and the four-bar hinges 13, 14, 15 connected to it, drives the fins 3 connected to these four-bar hinges 13, 14, 15. These thus also have a rotational movement, which they in turn transfer to the correspondingly connected fins 3 by means of the four-bar hinges 14, 15, 16 connected thereto.

Different opening angles α, β, γ can be realized by different configurations of the four-bar hinges 13, 14, 15, 16, 17.

The four-bar hinge 13; 14; 15; 16; 17 comprises a first hinge element 18 and a second hinge element 19, which are operatively connected to one another with the aid of a third hinge element 20 so that a movement of the first hinge element 18 can be transferred to the second hinge element 19. Thus, the four-hinge hinge 13; 14; 15; 16; 17 comprises the third hinge element 20, which is configured for the movement-transferring connection.

In the present embodiment examples, the hinge elements 18, 19, 20 are configured in the form of hinge arms, wherein the first hinge element 18 and the second hinge element 19 correspond to the lever arm 5. The four-hinge joints 13, 14, 15, 16, 17 or at least one or more of them could also comprise a motion link and a motion link arm and/or a gearwheel that engages with the motion link, or in other words, they can be configured in the form of the motion link and the motion link arm that engages with the motion link and/or in the form of a gearwheel.

The hinge elements 18, 19, 20 are connected to one another so as to be movable and movable relative to one another. The third hinge element 20 is thus movably arranged on the lever arm 5 of the fin 3. It can be seen in FIGS. 2 to 6 that fins 3 positioned in a central region of the fin arrangement 2 provide their lever arm 5 to two third hinge elements 20 or are movably connected thereto. Thus, these lever arms 5 are simultaneously configured in the form of the first hinge element 18 as well as in the form of the second hinge element 19, each taking into account the corresponding four-bar hinge 14; 15; 16.

In the present embodiment examples, the fins 3, which are operatively connected to the third hinge element 20, are arranged side-by-side in the frame 9. However, the third hinge elements 20 could also cross, for example, provided that the operatively connected fins 3 are not arranged side-by-side.

The four-bar hinges 13, 14, 15, 16, 17 are configured relative to one another such that the four-bar hinge assigned to the outer fin 3, in the present embodiment example the second four-bar hinge 14, has a maximum achievable opening angle γ. In other words, the third four-bar hinge 15, the fourth four-bar hinge 16, and the fifth four-bar hinge 17 result in a smaller opening angle α, β than the second four-bar hinge 14, wherein the four-bar hinges 15, 16, 17 achieve decreasing opening angles α, β in the stated order.

Each four-hinge hinge 13; 14; 15; 16; 17 has a first hinge point 21, a second hinge point 22, a third hinge point 23, and a fourth hinge point 24, wherein the first hinge point 21 and the second hinge point 22 are assigned to the first hinge element 18, the third hinge point 23 and the fourth hinge point 24 are assigned to the second hinge element 19, and the second hinge point 22 and the third hinge point 23 are assigned to the third hinge element 20. Depending on a positioning of the hinge points 21, 22, 23, 24 relative to one another, different four-bar hinges 13, 14, 15, 16, 17 can be realized.

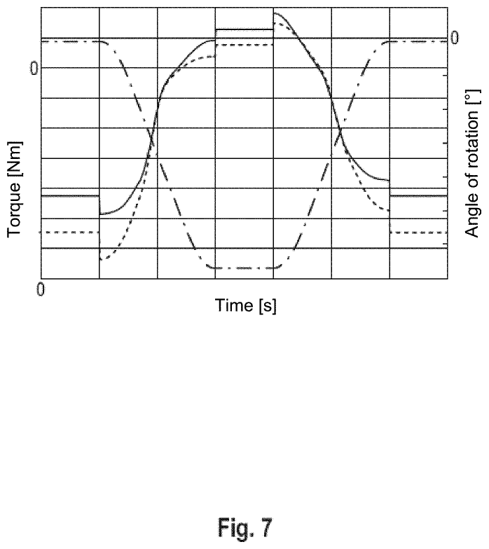

FIG. 7, in a diagram, shows the necessary torque and angle of rotation of the actuator of the air-conducting system 1 having the same four-bar hinges, whose torque demand is drawn by way of a dashed line, and the air-conducting system 1 according to aspects of the invention according to the first embodiment example, whose torque demand is drawn by way of a solid line, during a positioning of the air-conducting system 1, proceeding from the closed position, through intermediate positions, into the open position, and back into the closed position over time. The angle of rotation is drawn by way of a dot-dash line. An angle of rotation having a value of zero corresponds to a complete closure of the air-conducting system 1. In other words, the air-conducting system 1 is in its closed position. A significantly lower torque requirement of the air-conducting system 1 according to aspects of the invention is discernible, which can lead to a reduction in an energy demand of the motor vehicle.

### LIST OF REFERENCE NUMERALS

1 Air-conducting system
2 Fin arrangement
3 Fin
4 Coupling rod
5 Lever arm
6 Axis of rotation
7 First end
8 Second end
9 Frame
10 First arm-end portion
11 Second arm-end portion
12 Kinematics
13 First four-bar hinge
14 Second four-bar hinge
15 Third four-bar hinge
16 Fourth four-bar hinge
17 Fifth four-bar hinge
18 First hinge element
19 Second hinge element
20 Third hinge element
21 First hinge point
22 Second hinge point
23 Third hinge point
24 Fourth hinge point
Y frame axis
α Opening angle
β Opening angle
γ Largest opening angle

What is claimed is:

1. An air-conducting system of a motor vehicle body of a motor vehicle, said air-conducting system comprising:
a frame,
a fin arrangement including at least two fins, which are arranged in the frame in a rotatably mounted manner about their respective axes of rotation, wherein the fins are operatively connected by a split coupling rod for movement transmission, and
an actuator configured for initiating movement of the fin arrangement,
wherein the split coupling rod including at least two four-bar hinges that are configured differently from one another.

2. The air-conducting system according to claim 1, wherein a number of hinges of the different four-bar hinges corresponds to a number of the fins of the fin arrangement.

3. The air-conducting system according to claim 1, wherein one of the four-bar hinges having a maximum achievable opening angle (γ) is assigned to an outer fin of the fins.

4. The air-conducting system according to claim 3, wherein the outer fin is arranged facing a body exterior of the motor vehicle body.

5. The air-conducting system according to claim 1, wherein the actuator is arranged so as to drive one of the fins located in a central region of the fin arrangement.

6. The air-conducting system according to claim 1, wherein the four-bar hinge comprises a hinge element.

7. The air-conducting system according to claim 6, wherein the fins operatively connected to the hinge element are arranged side-by-side in the frame.

8. The air-conducting system according to claim 6, wherein the hinge element is movably arranged on a lever arm of one of the fins.

9. The air-conducting system according to claim 1, wherein the actuator is operatively connected to one of the fins by a first four-bar hinge of the at least two four-bar hinges.

10. The air-conducting system according to claim 1, wherein the four-bar hinge comprises a motion link, a motion link arm, and a gearwheel that engages with the motion link.

11. A motor vehicle body comprising the air-conducting system according to claim 1.

12. A motor vehicle comprising the motor vehicle body of claim 11.
